(19) United States
(12) Patent Application Publication
(10) Pub. No.: US 2025/0356465 A1
(43) Pub. Date: Nov. 20, 2025

(54) APPARATUS FOR DENOISING IMAGE OBTAINED THROUGH MULTISPECTRAL IMAGING SENSOR AND OPERATION METHOD THEREOF

(71) Applicants: SAMSUNG ELECTRONICS CO., LTD., Suwon-si (KR); UIF (University Industry Foundation), Yonsei University, Seoul (KR)

(72) Inventors: Sangyoon LEE, Suwon-si (KR); Moongi Kang, Seoul (KR); Woo-Shik Kim, Suwon-si (KR); Jinook Lee, Seoul (KR)

(73) Assignees: SAMSUNG ELECTRONICS CO., LTD., Seoul (KR); UIF (University Industry Foundation), Yonsei University, Seoul (KR)

(21) Appl. No.: 19/029,770

(22) Filed: Jan. 17, 2025

(30) Foreign Application Priority Data
May 20, 2024 (KR) 10-2024-0065358

(51) Int. Cl. G06T 5/70; G06T 5/50; G06T 7/174

(52) U.S. Cl. CPC G06T 5/70; G06T 5/50; G06T 7/174; G06T 2207/10036; G06T 2207/20221

(57) ABSTRACT

There is provided an apparatus for denoising an image obtained through a multispectral imaging sensor. The apparatus includes a processor dividing a wavelength band of an input image into a plurality of sub-wavelength bands, each of the plurality of sub-wavelength bands corresponding to one of a plurality of channels, obtaining, for each of the plurality of channels, a first denoising image and a differential image by sub-sampling the input image into a plurality of sub-sampled images, obtaining, for each of the plurality of channels, a second denoising image by performing preprocessing on the differential image of the respective channel and performing principal component analysis and projection on the preprocessed a differential image of the respective channel, and generating an output image by summing the first denoising image and the second denoising image obtained for each of the plurality of channels.

### CROSS-REFERENCE TO RELATED APPLICATION

This application is based on and claims the benefit of Korean Patent Application No. 10-2024-0065358, filed on May 20, 2024, in the Korean Intellectual Property Office, the disclosure of which is incorporated herein in its entirety by reference.

### BACKGROUND

### 1. Field

The disclosure relates to an apparatus for denoising an image obtained through a multispectral imaging sensor (MIS), and an operation method for denoising an image obtained through the MIS.

### 2. Description of the Related Art

A multispectral imaging sensor (MIS) includes four or more color channels, and each channel may sense light of different wavelength bands. As an image generated through the MIS includes noise, it is necessary to effectively denoise the image to increase image quality.

Related art denoising methods include a bilateral filter (BF) and a non-local means (NLM) filter which are used to measure the similarity between adjacent pixels, which may be effective in images of high spatial resolution.

### SUMMARY

As a filter array of a multispectral imaging sensor may simultaneously obtain light of different wavelength bands, a high spectral resolution is provided, and loss of a spatial resolution according thereto is unavoidable and noise in a low-illuminance situation may increase.

As an image generated through a multispectral imaging sensor has a low spatial resolution, when a related denoising method that is effectively performed in images of high spatial resolution is applied without change to an image generated through the multispectral imaging sensor, denoising efficiency may deteriorate.

According to one or more aspect of the disclosure, in order to effectively denoise an image obtained through a multispectral imaging sensor, there is provided a denoising apparatus including an algorithm for denoising that simultaneously considers spectral information and spatial information.

According to one or more aspect of the disclosure, there is provided a denoising method for denoising that simultaneously considers spectral information and spatial information.

The technical objectives to be achieved by the disclosure are not limited to the above-described objectives, and other technical objectives may be inferred from the following embodiments.

Additional aspects will be set forth in part in the description which follows and, in part, will be apparent from the description, or may be learned by practice of the presented embodiments.

According to an aspect of the disclosure, there is provided an apparatus for denoising an image obtained through a multispectral imaging sensor, the apparatus including: a memory configured to store one or more instructions, and at least one processor configured to execute the one or more instructions to: divide a wavelength band of an input image into a plurality of sub-wavelength bands, each of the plurality of sub-wavelength bands corresponding to one of a plurality of channels; obtain, for each of the plurality of channels, a first denoising image and a differential image by sub-sampling the input image into a plurality of sub-sampled images, each corresponding to one of the plurality of channels, the first denoising image obtained by preforming a denoising operation on a sub-sampled image for the respective channel and the differential image obtained based on a difference between the first denoising image and the sub-sampled image for the respective channel; obtain, for each of the plurality of channels, a second denoising image by performing preprocessing on the differential image of the respective channel and performing principal component analysis and projection on the preprocessed differential image of the respective channel; and generate an output image by summing the first denoising image and the second denoising image obtained for each of the plurality of channels.

The at least one processor may be further configured to: receive the input image including a visible light band and a non-visible light band, wherein the plurality of channels comprises at least four channels.

Each of the plurality of sub-sampled images for the respective channels may have a size of at least one multispectral filter array.

The at least one processor may be further configured to obtain the first denoising image and the differential image by applying a non-local means (NLM) algorithm to the plurality of sub-sampled images for the respective channels.

The at least one processor may be further configured to apply a bilateral filter (BF) algorithm and a bilinear interpolation to the differential image of each of the plurality of channels.

The at least one processor may be further configured to linearly transform the differential image preprocessed for each of the plurality of channels into a plurality of eigen vectors and a plurality of eigen values by performing the principal component analysis on a plurality of pixels of the differential image preprocessed for each of the plurality of channels.

The at least one processor may be further configured to: determine a priority of the plurality of eigen vectors based on the plurality of eigen values; and obtain the second denoising image by selecting and projecting at least one eigen vector from among the plurality of eigen vectors, based on the determined priority.

The at least one processor may be further configured to obtain the second denoising image by selecting and projecting a first number of eigen vectors of the plurality of eigen vectors.

The at least one processor may be further configured to obtain the second denoising image by selecting and projecting a number of eigen vectors set based on properties of the input image from among the plurality of eigen vectors.

The at least one processor may be further configured to: down-sample the second denoising image; and generate the output image by summing the first denoising image and the down-sampled second denoising image of each of the plurality of channels.

According to another aspect of the disclosure, there is provided an operation method of an apparatus for denoising an image obtained through a multispectral imaging sensor, the operation method including: dividing a wavelength band of an input image into a plurality of sub-wavelength bands, each of the plurality of sub-wavelength bands corresponding to one of a plurality of channels; obtaining, for each of the plurality of channels, a first denoising image and a differential image by sub-sampling the input image into a plurality of sub-sampled images, each corresponding to one of the plurality of channels, the first denoising image obtained by performing a denoising operation on a sub-sampled image for the respective channel and the differential image obtained based on a difference between the first denoising image and the sub-sampled image for the respective channel; obtaining, for each of the plurality of channels, a second denoising image by performing preprocessing on the differential image of the respective channel and performing principal component analysis and projection on the preprocessed a differential image of the respective channel; and generating an output image by summing the first denoising image and the second denoising image obtained for each of the plurality of channels.

The method may further include receiving the input image including a visible light band and a non-visible light band, wherein the plurality of channels comprises at least four channels.

Each of the plurality of sub-sampled images for the respective channels may have a size of at least one multispectral filter array.

The obtaining of the first denoising image and the differential image may include obtaining the first denoising image and the differential image by applying a non-local means (NLM) algorithm to the plurality of sub-sampled images for the respective channels.

The performing of the preprocessing on the differential image may include applying a bilateral filter (BF) algorithm and a bilinear interpolation to the differential image of each of the plurality of channels.

The obtaining of the second denoising image may include linearly transforming the differential image preprocessed for each of the plurality of channels into a plurality of eigen vectors and a plurality of eigen values by performing the principal component analysis on a plurality of pixels of the differential image preprocessed for each of the plurality of channels.

The method may further include determining a priority of the plurality of eigen vectors based on the plurality of eigen value; and obtaining the second denoising image by selecting and projecting at least one eigen vector from among the plurality of eigen vectors, based on the determined priority.

The method may further include obtaining the second denoising image by selecting and projecting a preset number of eigen vectors of the plurality of eigen vectors.

The method may further include obtaining the second denoising image by selecting and projecting a number of eigen vectors set based on properties of the input image from among the plurality of eigen vectors.

The generating of the output image may include: down-sampling the second denoising image; and generating the output image by summing the first denoising image and the down-sampled second denoising image, for each of the plurality of channels.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a denoising apparatus according to an embodiment;

FIG. 2 is an example view of a wavelength band of a red, green, and blue (RGB) sensor;

FIGS. 3 and 4 are example views of a wavelength band of a multispectral imaging sensor;

FIG. 5 is a flowchart of an operation method of a denoising apparatus according to an embodiment;

FIG. 6 is an example view of a filter array of a multispectral imaging sensor;

FIG. 7 is an example view illustrating a method of obtaining a first denoising image and a differential image through a first denoising portion, according to an embodiment;

FIG. 8 is an example view illustrating a method of obtaining a differential image preprocessed through a second denoising portion, according to an embodiment;

FIG. 9 is an example view illustrating a method of obtaining a second denoising image by performing principal component analysis and projection on the differential image preprocessed through the second denoising portion, according to an embodiment;

FIG. 10 is an example view illustrating a method of performing down-sampling on the second denoising image through a denoised image output portion, according to an embodiment;

FIG. 11 is an example view illustrating a method of generating an output image by summing a first denoising image and a down-sampled second denoising image, for each channel, through the denoised image output portion, according to an embodiment;

FIG. 12 is a block diagram of a schematic structure of an electronic device according to an embodiment;

FIG. 13 is a block diagram schematically showing a camera module provided in an electronic device of FIG. 12; and

FIGS. 14 to 23 illustrate various examples of an electronic device adopting a multispectral imaging sensor, according to embodiments.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items.

Hereinafter, embodiments will be described in detail with reference to the attached drawings. Throughout the drawings, like reference numerals denote like elements, and sizes of components in the drawings may be exaggerated for convenience of explanation and clarity. In this regard, the embodiments may have different forms and should not be construed as being limited to the descriptions set forth herein.

When a constituent element is provided “above” or “on” to another constituent element, the constituent element may include not only an element directly contacting and provided on the other constituent element, but also an element provided above the other constituent element in a non-contact manner. As used herein, the singular forms “a,” “an,” and “the” are intended to include the plural forms as well, unless the context clearly indicates otherwise. Furthermore, when a part may “include” a certain constituent element, unless specified otherwise, it may not be construed to exclude another constituent element but may be construed to further include other constituent elements. The use of the terms “a,” “an,” “the,” and similar referents in the context of describing the disclosure is to be construed to cover both the singular and the plural.

Furthermore, some embodiments related to function blocks, units, and/or modules are described with reference to the accompanying drawings. Those skilled in the art will appreciate that these blocks, units and/or modules are physically implemented by logic circuits, individual components, microprocessors, hard-wired circuits, memory devices, wiring connections, and other electronic circuits. This may be formed by using semiconductor-based manufacturing technology or other manufacturing technologies. For blocks, units, and/or modules implemented by microprocessors or other similar hardware, they may be programmed and controlled using software to perform various functions discussed in the disclosure, and may be selectively driven by firmware and/or software. Furthermore, each block, unit, and/or module may be implemented by dedicated hardware, or by a combination of dedicated hardware performing some functions and processors (e.g., one or more programmed microprocessors and related circuitry) performing other functions. Furthermore, in some embodiments, blocks, units, and/or modules may be physically separated into two or more individual blocks, units, and/or modules that interact with each other without departing from the scope of the disclosure. Furthermore, in some embodiments block, blocks, units, and/or modules may be combined into physically more complex blocks, units, and/or modules without departing from the scope of the disclosure.

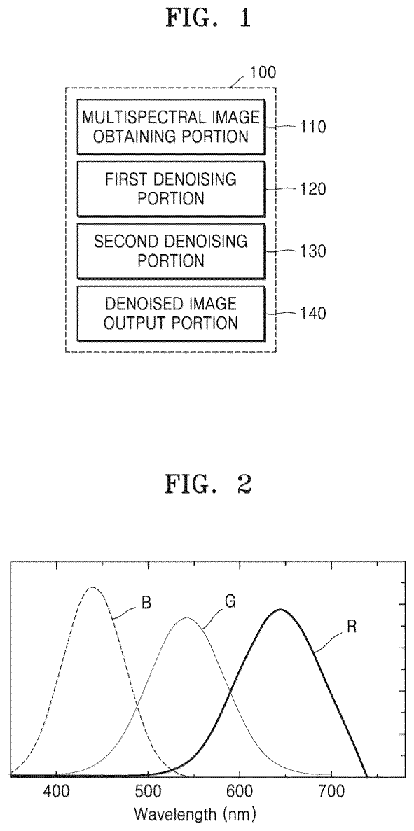

FIG. 1 is a block diagram of a denoising apparatus 100 according to an embodiment.

Referring to FIG. 1, the apparatus 100 for denoising an image may include a multispectral image obtaining portion 110, a first denoising portion 120, a second denoising portion 130, and a denoised image output portion 140. However, the denoising apparatus 100 of FIG. 1 is illustrated with only components related to illustrating certain features of the embodiments. However, the disclosure is not limited thereto, and as such, according to other embodiments the denoising apparatus 100 may further include components other than those illustrated in FIG. 1. According to an embodiment, the multispectral image obtaining portion 110, the first denoising portion 120, the second denoising portion 130, and the denoised image output portion 140 may be implemented by logic circuits, individual components, microprocessors, hard-wired circuits, memory devices, wiring connections, and other electronic circuits. For example, the multispectral image obtaining portion 110 may be a multispectral imaging sensor. In another embodiment, the obtaining portion 110, the first denoising portion 120, the second denoising portion 130, and the denoised image output portion 140 may be implemented by executing software code or program on a processor. However, the disclosure is not limited thereto, and as such, the components illustrated in FIG. 1 may be illustrated in another manner.

In an embodiment, the multispectral image obtaining portion 110 may include a plurality of channels. For example, the multispectral image obtaining portion 110 may include at least four channels, but the disclosure is not limited thereto. As such, according to another example, the multispectral image obtaining portion 110 may include sixteen (16) channels or thirty-one (31) channels.

In an embodiment, each channel of the multispectral image obtaining portion 110 may correspond to one of a plurality of sub-wavelength bands of the wavelength band of an input image. For example, a number of the channels may correspond to a number of the plurality of sub-wavelength bands, and as such, the multispectral image obtaining portion 110 may be configured to and sense each of plurality of sub-wavelength bands. For example, the multispectral image obtaining portion 110 may receive light corresponding to an image (e.g., an input image) in a wavelength band including a visible light band and a non-visible light band. The multispectral image obtaining portion 110 may divide the wavelength band into a plurality of sub-wavelength bands, each of the plurality of sub-wavelength bands corresponding to one of a plurality of channels. For example, the multispectral image obtaining portion 110 may divide the wavelength band into at least four sub-wavelength bands, each corresponding to one of at least four channels with respect to the received input image. According to an embodiment, in order to sense light of a desired band, each of the plurality of channels of the multispectral image obtaining portion 110 may adjust the central wavelength, bandwidth, and transmission amount of light absorbed through the corresponding channel.

In an embodiment, the multispectral image obtaining portion 110 may obtain an input image through at least one multispectral filter array. For example, In an embodiment, the multispectral image obtaining portion 110 may obtain electric signal based on light corresponding to the input image through at least one multispectral filter array. For example, a multispectral filter array may be configured such that sixteen (16) channels are arranged in the form of a 4×4 array, and the multispectral image obtaining portion 110 may include a plurality of multispectral filter arrays. Accordingly, the multispectral image obtaining portion 110 may be provided in a 16×16 array.

In an embodiment, the multispectral filter array may have a one-dimensional or two-dimensional array.

In an embodiment, each channel filter or unit filter of a multispectral filter array may have a resonance structure. A transmission band of a filter may be determined based on the resonance structure. For example, the transmission band of a filter may be determined based on the material composition of a reflection plate, the material composition of a cavity, and the thickness of a cavity.

Furthermore, the multispectral filter array may be implemented through various manner. For example, the multispectral filter array may be implement through a structure including, but is not limited to, gratings, nano-structures, and distributed Bragg reflectors (DBRs).

In an embodiment, the first denoising portion 120 may sub-sample the input image into images for the respective channels. For example, the first denoising portion 120 may sub-sample the input image into a plurality of sub-sampled images, each corresponding to one of the plurality of channels.

For example, the multispectral imaging sensor may include at least four multispectral filter arrays, and each of the at least four multispectral filter arrays ma include sixteen (16) channels are arranged in a 4×4 array. The first denoising portion 120 may sub-sample the input image obtained from four multispectral filter arrays, each being arranged in a 4×4 array, into images for the respective channels. For example, each of the sub-sampled images for the respective channels may have the size of the multispectral filter array.

According to an embodiment, the first denoising portion 120 may normalize an image for each channel of the sub-sampled images for the respective channels. For example, since the image for each channel is obtained through a different spectrum (e.g., different wavelength band) and has a different pixel value, a maximum value and a minimum value of the image for each channel may be normalized. For example, the maximum value and the minimum value of the image for each channel may be normalized equally.

In an embodiment, the first denoising portion 120 may obtain a first denoising image and a differential image. For example, the first denoising portion 120 may obtain the first denoising image and the differential image by performing a denoising operation on the images for the respective channels. For example, the term “differential image” of a respective channel may refer to a difference image between a sub-sampled image of the respective channel and the first denoising image. For example, the differential image may include noise information and part of actual image information. The meaningful image information may be information related to the actual image without noise.

For example, the first denoising portion 120 may denoise the sub-sampled images for the respective channels by applying a non-local means (NLM) algorithm. The NLM algorithm is a denoising algorithm of comparing similarity between adjacent group pixels, applying a high weight to a group pixel with high similarity, and summing values of the respective pixels. The NLM algorithm may be calculated through Equation (1).

$$NLM ( x ) = {\sum }_{y ∈ I} I ( y ) \cdot h ( {‖ I ( Nx ) - I ( Ny ) ‖}^{2} ) \qquad [ Equation ( 1 ) ]$$

Here, x may denote a target pixel, and y may denote all pixels in an image. Furthermore, Ni may refer to a group of adjacent pixels around a coordinate i, and h( ) may refer to normalized spectral similarity.

However, the disclosure is not limited thereto, and as such, according to another embodiment, the first denoising portion 120 may denoise sub-sampled images for the respective channels by using a denoising algorithm other than the NLM algorithm. For example, the first denoising portion 120 may use an algorithm including, but not limited to, a Gaussian filter, a medium filter, a bilateral filter (BF).

Accordingly, the first denoising portion 120 may obtain the first denoising image corresponding to the sub-sampled images of the respective channels and a differential image based on difference between the sub-sampled image of the respective channel and the first denoising image. For example, the first denoising portion 120 may obtain the first denoising image by passing the sub-sampled image for the respective channel through the NLM algorithm, and obtain a differential image corresponding to a difference between the sub-sampled image for the respective channel and the first denoising image.

In an embodiment, the second denoising portion 130 may perform preprocessing on the differential image through a BF algorithm and a bilinear interpolation.

For example, the second denoising portion 130 may apply the BF algorithm to a differential image for each of the plurality of channels between the images for the respective channels and the first denoising image. The BF algorithm is a denoising algorithm of considering geographical similarity and spectral similarity between adjacent pixels within the same channel, which may maintain details and edges of an image. The BF algorithm may be calculated through Equation (2).

$$BF ( x ) = {\sum }_{{x}^{′} ∈ N ( x )} I ( {x}^{′} ) \cdot f ( ‖ x - {x}^{′} ‖ ) \cdot g ( ‖ I ( x ) - I ( {x}^{′} ) ‖ ) \qquad [ Equation ( 2 ) ]$$

Here, N(x) may refer to a set of adjacent pixels with respect to a coordinate x, f( ) may refer to a normalized geographical similarity, and g( ) may refer to a normalized spectral similarity.

However, the disclosure is not limited thereto, and as such, according to another embodiment, the second denoising portion 130 may denoise a differential image for each of the plurality of channels between the images for the respective channels and the first denoising image by using a denoising algorithm other than the BF algorithm. For example, the second denoising portion 130 may use an algorithm including, but not limited to, a Gaussian filter, a medium filter, a non-local means filter, etc.

Furthermore, the second denoising portion 130 may apply the bilinear interpolation to the differential image for each of the plurality of channels to which the BF algorithm has been applied. The bilinear interpolation may be an up-sampling algorithm to adjust registration between channels. In an example case in which the input image obtained through the multispectral image obtaining portion 110 is arranged in a 16×16 array, and the sub-sampled images for the respective channels are arranged in a 4×4 array, the second denoising portion 130 may apply the BF algorithm to a differential image for each of the plurality of channels arranged in a 4×4 array and then, to adjust registration between channels, the bilinear interpolation thereto so as to be arranged in a 16×16 array. In other words, the preprocessed differential image for the respective channels may be provided in a 16×16 array.

In an embodiment, the second denoising portion 130 may obtain a second denoising image by performing principal component analysis and projection on the differential image preprocessed for each of the plurality of the channels. Here, the term “second denoising image” may include image information estimated as a meaningful signal in a differential image for each of the plurality of channels including noise and part of meaningful image information. For example, the second denoising portion 130 may estimate the meaningful image information included with noise through the preprocessing (i.e., the BF algorithm and the bilinear interpolation), the principal component analysis, and the projection on a differential image for each of the plurality of channels.

In an embodiment, the second denoising portion 130 may perform a linear transformation on a plurality of pixels of a differential image preprocessed for each of the plurality of channels into a plurality of eigen vectors and a plurality of eigen values, by performing principal component analysis on the plurality of pixels of a differential image preprocessed for each of the plurality of channels, on a spectral axis of each of the plurality of channels. The principal component analysis is a method of extracting a principal component of a plurality of independent variables included in multi-dimensional data, of which main purpose is to reduce a dimension. In the principal component analysis, the eigen vector may refer to a principal axis direction in which a matrix operates on a specific vector through a linear transformation, and the eigen value may refer to a degree of the matrix operating on a specific vector through the linear transformation.

For example, the second denoising portion 130 may linearly transform a differential image preprocessed for each of the plurality of channels into sixteen (16) eigen vectors and sixteen (16) eigen values, by performing principal component analysis on a plurality of pixels of a preprocessed differential image for each of sixteen (16) channels arranged in a 16×16 array, on a spectral axis of each of the plurality of channels. Here, the sixteen (16) eigen values may refer to a degree of effect of image information of a channel on the input data in order of size. In other words, an eigen value having a large size may refer to a principal component constituting an image, not noise.

In an embodiment, the second denoising portion 130 may determine the priority of a plurality of eigen vectors based on a plurality of eigen values, and obtain a second denoising image by selecting and projecting at least one eigen vector from among a plurality of eigen vectors based on the determined priority. For example, the second denoising portion 130 may obtain the second denoising image by selecting and projecting a reference number of eigen vectors from among a plurality of eigen vectors. The reference number may be a preset number. For example, the preset number may be 3. However, the disclosure is not limited thereto. In another example, the second denoising portion 130 may obtain the second denoising image by selecting and projecting the number of eigen vectors set based on the properties of an input image from among a plurality of eigen vectors.

In an embodiment, the denoised image output portion 140 may generate an output image by summing, for each of the plurality of channels, the first denoising image and the second denoising image. For example, the denoised image output portion 140 may generate an output image by down-sampling the second denoising image obtained by the second denoising portion 130 and summing, for each of the plurality of channels, the first denoising image and the down-sampled second denoising image. In this state, the location of down-sampling for each of the plurality of channels in the second denoising image is the same as the location of sub-sampling of an input image into images for the respective channels in the first denoising portion 120.

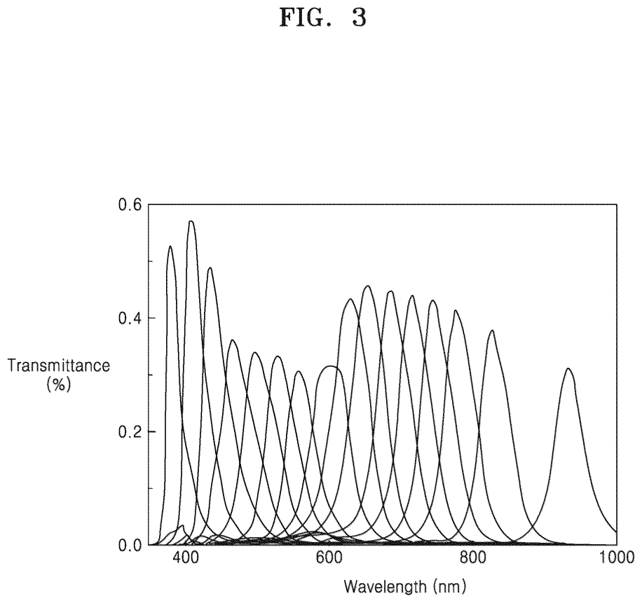

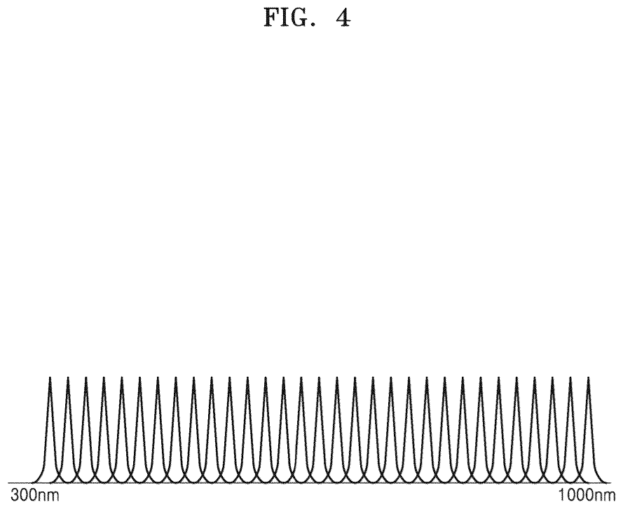

FIG. 2 is an example view of a wavelength band of a red, green, and blue (RGB) sensor. FIGS. 3 and 4 are example views of a wavelength band of a multispectral imaging sensor.

Referring to FIG. 2, the RGB sensor may include an R channel, a G channel, and a B channel, and may sense light of a wavelength band corresponding to each of the three channels. Unlike the above, a multispectral imaging sensor (e.g., the multispectral image obtaining portion 110 of FIG. 1) may include sixteen (16) channels. However, the disclosure is not limited thereto, and as such, the multispectral imaging sensor may include a number of channels different than sixteen.

The multispectral imaging sensor may adjust the central wavelength, bandwidth, and transmission amount of light absorbed through the corresponding channel to allow each of the plurality of channels to sense light of a desired band. For example, the bandwidth of each of the plurality of channels of the multispectral imaging sensor may be set to be narrower than the band width of each of the R channel, the G channel, and the B channel. Furthermore, the total bandwidth that is a sum of the bandwidths of all channels of the multispectral imaging sensor may include the total bandwidth of the RGB sensor and may be wider than the same. The image obtained by the multispectral imaging sensor may be a multispectral image. The multispectral imaging sensor may obtain an image by dividing a relatively wide wavelength band including a visible light band and a non-visible light band (an infrared band, an ultraviolet band, etc.) into a plurality of channels.

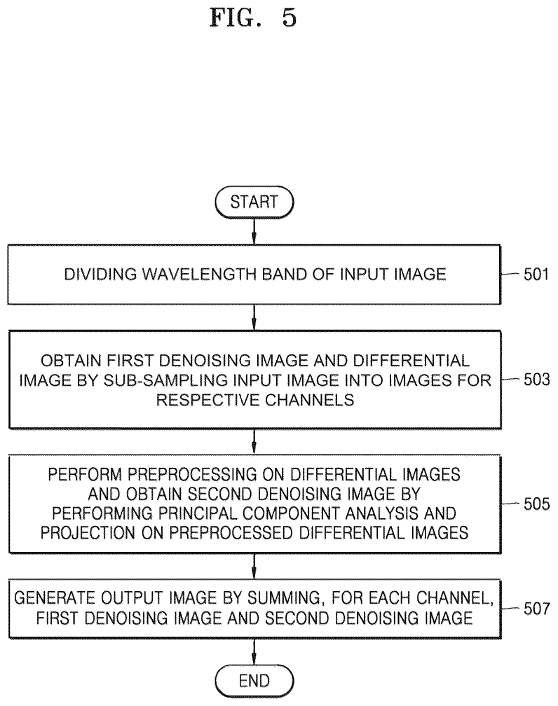

FIG. 5 is a flowchart of an operation method of a denoising apparatus according to an embodiment.

Referring to FIG. 5, in operation 501, the method may include dividing a wavelength band of an input image into a plurality of channels. For example, an apparatus (e.g., the denoising apparatus 100 of FIG. 1) for denoising an image obtained may include a multispectral imaging sensor configured to sense light of a wavelength band corresponding to an input image by dividing the wavelength band of the input image into a plurality of sub-wavelength band, each corresponding to one of the plurality of channels. For example, the multispectral image obtaining portion 110 may be referred to as a multispectral imaging sensor.

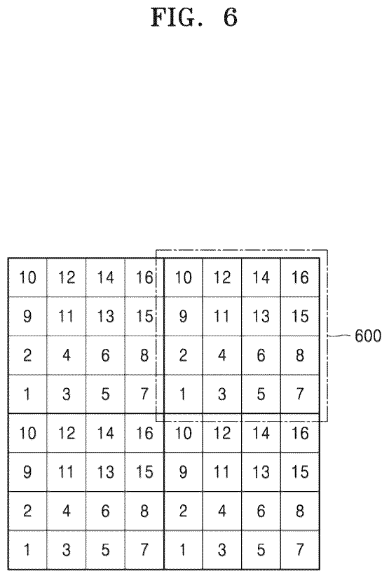

In an embodiment, the multispectral image obtaining portion 110 may obtain an input image through at least one multispectral filter array. Referring to FIG. 6, the multispectral image obtaining portion 110 may obtain an input image through four multispectral filter arrays 600, and each multispectral filter array 600 may be configured in an array form in which sixteen (16) channels are arranged in a 4×4 array.

In an embodiment, each of the plurality of channels of the multispectral image obtaining portion 110 may sense each of a plurality of sub-wavelength bands by dividing the wavelength band of an input image. For example, the multispectral image obtaining portion 110 may receive an input image including a visible light band and a non-visible light band, and sense light of a wavelength band by dividing the wavelength band through sixteen (16) channels with respect to the received input image. For example, in order to sense light of a desired band, each of the plurality of channels of the multispectral image obtaining portion 110 may adjust the central wavelength, bandwidth, and transmission amount of light absorbed through the corresponding channel.

According to an embodiment, in operation 503, the method may include obtaining a first denoising image and a differential image by sub-sampling the input image. For example, the denoising apparatus 100 may obtain a first denoising image and a differential image by sub-sampling the input image into images for the respective channels through a first denoising portion and denoising the images for the respective channels.

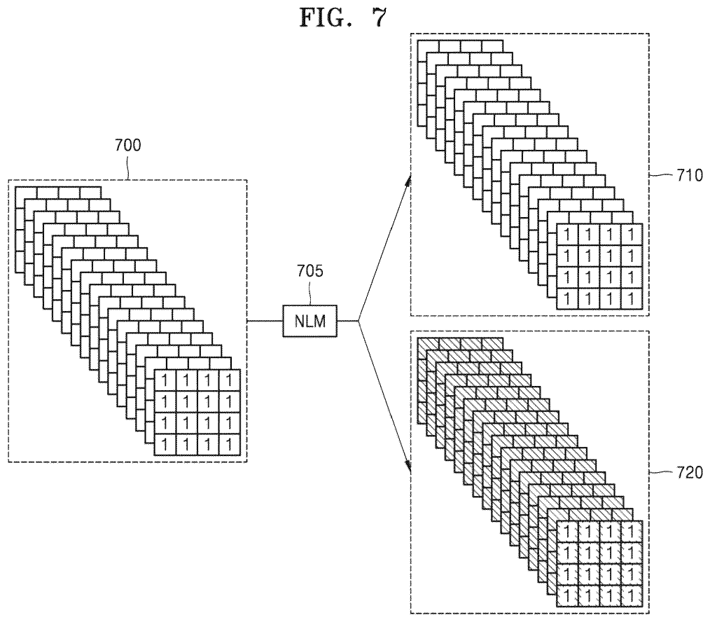

FIG. 7 is an example view illustrating an operation of obtaining a first denoising image and a differential image through a first denoising portion, according to an embodiment. Referring to FIG. 7, a first denoising portion (e.g., the first denoising portion 120 of FIG. 1) may sub-sample the input image obtained by the multispectral imaging sensor arranged in a 16×16 array into a plurality of sub-sampled images 700 for the respective channels. For example, the first denoising portion may sub-sample the input image into 16 sub-sampled images 700. For example, as each of the sub-sampled images for the respective channels is arranged in a 4×4 array, the size of each of the sub-sampled images for the respective channels may be ¼ of the size of the multispectral imaging sensor, but the disclosure is not limited thereto.

In an embodiment, the first denoising portion 120 may denoise the sub-sampled images for the respective channels by applying an NLM algorithm 705 thereto. For example, as the sub-sampled images 700 for the respective channels pass through the NLM algorithm 705, first denoising images 710 and differential images 720 corresponding to a difference between the images 700 for the respective channels and the first denoising images 710 may be obtained.

According to an embodiment, in operation 505, the method may include performing preprocessing on the differential images through the second denoising portion, and obtain a second denoising image by performing principal component analysis and projection on the preprocessed differential images. For example, the denoising apparatus 100 may perform preprocessing on the differential images through the second denoising portion, and obtain a second denoising image by performing principal component analysis and projection on the preprocessed differential images.

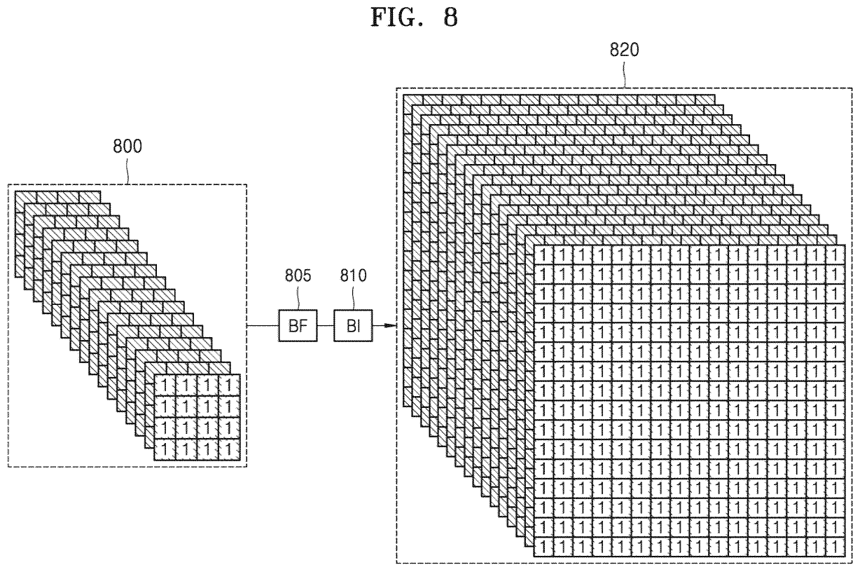

FIG. 8 is an example view illustrating an operation of obtaining a differential image preprocessed through a second denoising portion, according to an embodiment. Referring to FIG. 8, differential images 800 for the respective channels are the same as the differential images 720 corresponding to the difference between the images 700 for the respective channels and the first denoising images 710 in FIG. 7. In an embodiment, a second denoising portion (e.g., the second denoising portion 130 of FIG. 1) may perform preprocessing on the differential images 800 for the respective channels. For example, the second denoising portion 130 may perform preprocessing by applying a BF algorithm 805 and a bilinear interpolation (BI) 810 to the differential images 800 for the respective channels.

In an embodiment, the differential images 800 for the respective channels including noise and part of image information may pass through the BF algorithm 805, and the BF algorithm 805 may denoise the differential images 800 for the respective channels through a weight coefficient reflecting similarity between pixels. For example, in order to apply a high weight to pixels having a small different from a center pixel, the weight of the BF algorithm 805 may be set in inverse proportion to a difference between the center pixel and an adjacent pixel.

In an embodiment, the differential images 800 for the respective channels having passed through the BF algorithm 805 may be up-sampled through the BI 810. The BI 810 may be an up-sampling algorithm to adjust registration between channels.

In an example case in which the differential images 800 for the respective channels are arranged in a 4×4 array, the second denoising portion 130 may allow the preprocessed differential images 820 for the respective channels to be arranged in a 16×16 array, by applying the BI 810 on the differential images 800 for the respective channels having passed through the BF algorithm 805.

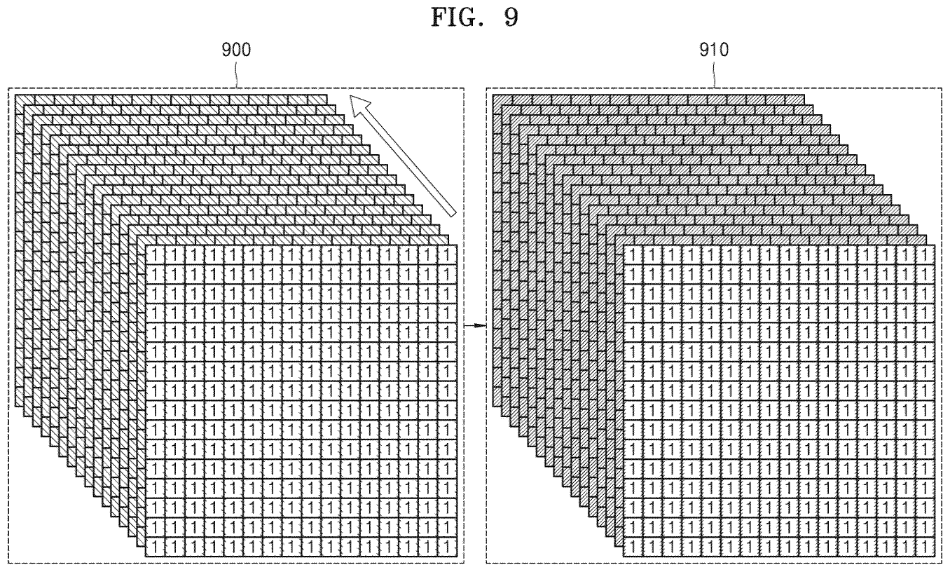

FIG. 9 is an example view of obtaining a second denoising image by performing principal component analysis and projection on the differential image preprocessed through the second denoising portion, according to an embodiment. Referring to FIG. 9, preprocessed differential images 900 for the respective channels are the same as the preprocessed differential images 820 for the respective channels in FIG. 8.

In an embodiment, the second denoising portion 130 may obtain second denoising images 910 by performing principal component analysis and projection on the preprocessed differential images 900 for the respective channels.

In an embodiment, the second denoising portion 130 may perform a linear transformation into a plurality of eigen vectors and a plurality of eigen values by performing principal component analysis on a plurality of pixels of the preprocessed differential images 900 for the respective channels. For example, the second denoising portion 130 may perform a linear transformation on the preprocessed differential images 900 for the respective channels into sixteen (16) eigen vectors and sixteen (16) eigen values. For example, an eigen value having a large size may refer to a principal component constituting an image, not noise.

In an embodiment, the second denoising portion 130 may determine the priority of a plurality of eigen vectors based on a plurality of eigen values, and obtain the second denoising images 910 by selecting and projecting at least one eigen vector from among a plurality of eigen vectors based on the determined priority.

For example, the second denoising portion 130 may obtain the second denoising images 910 by selecting and projecting the preset number of eigen vectors from among a plurality of eigen vectors. For example, the second denoising portion 130 may determine the priority of a plurality of eigen vectors by listing the plurality of eigen values in descending order starting from the largest value. In other words, among the sixteen (16) eigen values, the priority of an eigen vector having the largest eigen value may be determined such that “rank=1,” and the priority of an eigen vector having the smallest eigen value may be determined such that “rank=16.” Then, the second denoising portion 130 may obtain the second denoising images 910 by selecting and projecting the preset number (e.g., three) of eigen vectors from among a plurality of eigen vectors listed based on the determined priority.

In another embodiment, the second denoising portion 130 may obtain the second denoising images 910 by selecting and projecting the number of eigen vectors set based on the properties of an input image among a plurality of eigen vectors. For example, the second denoising portion 130 may calculate a plurality of eigen values through Equation (3).

$$\frac{{\sum }_{i = 1}^{r} {σ}_{i}^{2}}{{\sum }_{i = 1}^{16} {σ}_{i}^{2}} < τ \qquad [ Equation ( 3 ) ]$$

In other words, the second denoising portion 130 may obtain, through Equation (3), the maximum value of r at which a ratio of the sum of square values of r eigen values to the sum of square values of sixteen (16) eigen values is less than a threshold value T. For example, the threshold value T may be set based on the properties of an input image. For example, the threshold value T may be 0.15. In an example case in which a ratio of the sum of square values of two eigen values to the sum of square values of sixteen (16) eigen values is 0.13, and a ratio of the sum of square values of three eigen values to the sum of square values of sixteen (16) eigen values is 0.16, the maximum value of r may be determined to be “2.” Accordingly, the second denoising portion 130 may obtain the second denoising images 910 by selecting and projecting eigen vectors with “rank=1” and “rank=2” having a large eigen value, from among sixteen (16) eigen values.

In an embodiment, the second denoising portion 130 may obtain a second denoising image having only meaningful image information from a differential image including noise and meaningful image information, by selecting and projecting at least one eigen vector from among a plurality of eigen vectors based on the determined priority.

According to an embodiment, in operation 507, the method may include output an image by summing, for each of the plurality of channels, the first denoising image and the second denoising image through the denoised image output portion. For example, the denoising apparatus 100 may generate an output image by summing, for each of the plurality of channels, the first denoising image and the second denoising image through the denoised image output portion.

FIG. 10 is an example view of performing down-sampling on the second denoising image through a denoised image output portion, according to an embodiment. In other words, in generating an output image by summing the first denoising image and the second denoising image, a down-sampling operation on the second denoising image may precede. Referring to FIG. 10, second denoising images 1000 are the same as the second denoising images 910 in FIG. 9.

In an embodiment, a denoised image output portion (e.g., the denoised image output portion 140 of FIG. 1) may down-sample the second denoising images 1000. The denoised image output portion 140 may down-sample the second denoising images 1000 in combining the second denoising images 1000 with the first denoising images generated through the first denoising portion 120, to improve details of an image and simultaneously minimize a noise regeneration problem in a flat area.

In an example case in which the second denoising images 1000 are arranged in a 16×16 array, the denoised image output portion 140 may obtain down-sampled second denoising images 1010 arranged in a 4×4 array by down-sampling the second denoising images 1000.

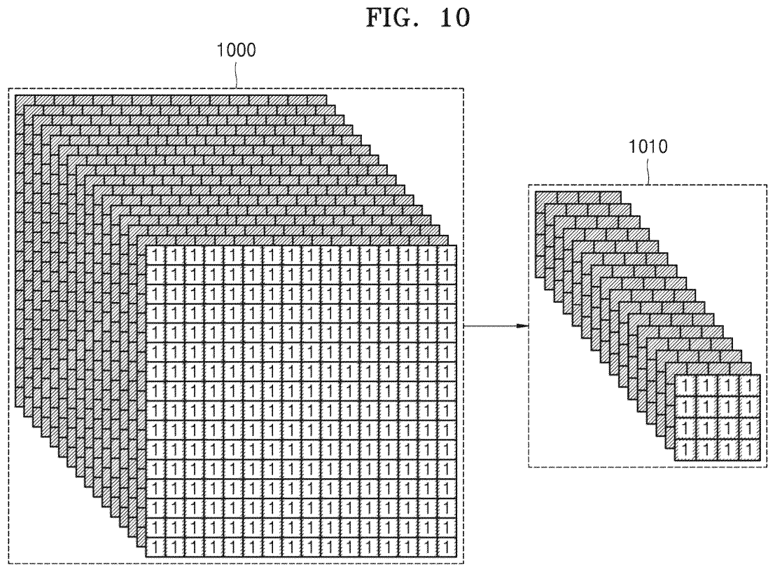

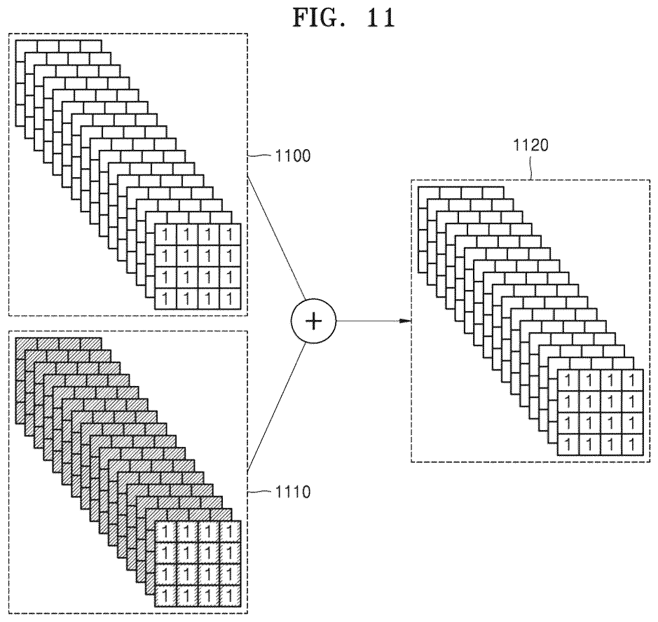

FIG. 11 is an example view of generating an output image by summing a first denoising image and a down-sampled second denoising image, for each of the plurality of channels, through the denoised image output portion, according to an embodiment. Referring to FIG. 11, first denoising images 1100 are the same as the first denoising images 710 in FIG. 7, and the down-sampled second denoising images 1110 are the same as the down-sampled second denoising images 1010 in FIG. 10.

In an embodiment, a denoised image output portion (e.g., the denoised image output portion 140 of FIG. 1) may generate output images 1120 by summing the first denoising images 1100 and the down-sampled second denoising images 1110, for each of the plurality of channels. The output images 1120 may be image obtained by removing noise only without substantial removing of image information from the original image obtained from the multispectral image obtaining portion 110.

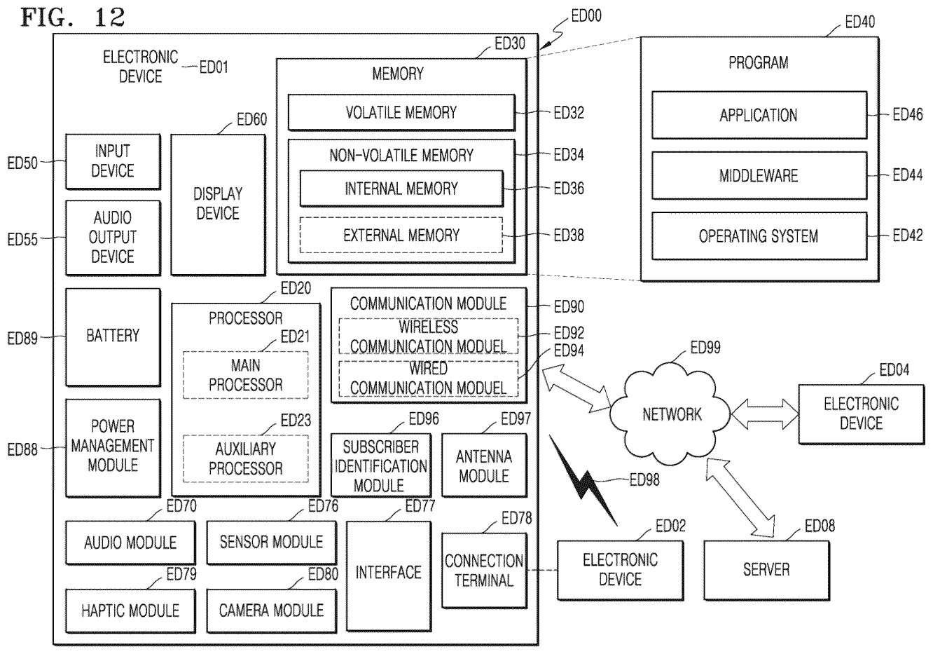

FIG. 12 is a block diagram of a schematic structure of an electronic device according to an embodiment.

Referring to FIG. 12, in a network environment ED00, an electronic device ED01 may communicate with another electronic device ED02 through a first network ED98 (a short-range wireless communication network, etc.), or communicate with another electronic device ED04 and/or a server ED08 through a second network ED99 (a long-range wireless communication network, etc.). The electronic device ED01 may communicate with the electronic device ED04 through the server ED08. The electronic device ED01 may include a processor ED20, a memory ED30, an input device ED50, an audio output device ED55, a display device ED60, an audio module ED70, a sensor module ED76, an interface ED77, a haptic module ED79, a camera module ED80, a power management module ED88, a battery ED89, a communication module ED90, a subscriber identification module ED96, and/or an antenna module ED97. In the electronic device ED01, some of the constituent elements (the display device ED60 etc.) may be omitted or another constituent element may be added. Some of these constituent elements may be implemented as one integrated circuit. For example, the sensor module ED76 (a fingerprint sensor, an iris sensor, an illuminance sensor, etc.) may be implemented by being embedded in the display device ED60 (a display etc.). Furthermore, in an example case in which a multispectral imaging sensor includes a spectral function, some functions (a killer sensor or an illumination sensor) of the sensor module ED76 may be implemented in the multispectral imaging sensor, not a separate sensor module.

The processor ED20 may control, by executing software (a program ED40, etc.), one or a plurality of other constituent elements (a hardware or software constituent element, etc.) of the electronic device ED01, and perform various data processing or operations. As part of data processing or operations, the processor ED20 may load commands and/or data received from other constituent elements (the sensor module ED76, the communication module ED90, etc.) in a volatile memory ED32, process the command and/or data stored in the volatile memory ED32, and store resultant data in a non-volatile memory ED34. The processor ED20 may include a main processor ED21 (a central processing unit, an application processor, etc.) and an auxiliary processor ED23 (a graphics processing unit, an image signal processor, a sensor hub processor, a communication processor, etc.), which are operable independently or together. The auxiliary processor ED23 may consume less power than the main processor ED21 and may perform a specialized function.

In an example case in which the main processor ED21 is in an inactive state (a sleep state), the auxiliary processor ED23 may control functions and/or states related to some constituent elements (the display device ED60, the sensor module ED76, the communication module ED90, etc.) of the electronic device ED01, instead of the main processor ED21. In an example case in which the main processor ED21 is in an active state (an application execution state), the main processor ED21 may control functions and/or states related to some constituent elements (the display device ED60, the sensor module ED76, the communication module ED90, etc.) of the electronic device ED01. The auxiliary processor ED23 (an image signal processor, a communication processor, etc.) may be implemented as a part of functionally related other constituent elements (the camera module ED80, the communication module ED90, etc.).

The memory ED30 may store various pieces of data needed for constituent element (the processor ED20, the sensor module ED76, etc.) of the electronic device ED01. The data may include, for example, software (the program ED40 etc.) and input data and/or output data regarding commands related thereto. The memory ED30 may include the volatile memory ED32 and/or the non-volatile memory ED34. The non-volatile memory ED34 may include an internal memory ED36 fixedly installed in the electronic device ED01 and an external memory ED38 that is detachable.

The program ED40 may be stored as software in the memory ED30, and may include an operating system ED42, a middleware ED44, and/or an application ED46.

The input device ED50 may receive commands and/or data to be used in the constituent elements (the processor ED20 etc.) of the electronic device ED01, from the outside (a user etc.) of the electronic device ED01. The input device ED50 may include a microphone, a mouse, a keyboard, and/or a digital pen (a stylus pen etc.).

The audio output device ED55 may output an audio signal to the outside of the electronic device ED01. The audio output device ED55 may include a speaker and/or a receiver. The speaker may be used for general purposes such as multimedia playback or recording playback, and the receiver may be used to receive incoming calls. The receiver may be combined as a part of the speaker or implemented as an independent separate device.

The display device ED60 may visually provide information to the outside of the electronic device ED01. The display device ED60 may include a display, a hologram device, or a projector, and a control circuit for controlling such a device. The display device ED60 may include a touch circuitry set to sense a touch, and/or a sensor circuit (a pressure sensor etc.) set to measure the strength of a force generated by the touch.

The audio module ED70 may convert sound into an electrical signal or reversely an electrical signal into sound. The audio module ED70 may obtain sound through the input device ED50, or output sound through the audio output device ED55 and/or a speaker and/or a headphone of another electronic device (the electronic device ED02, etc.) connected to the electronic device ED01 in a wired or wireless manner.

The sensor module ED76 may sense an operation state (power, a temperature, etc.) of the electronic device ED01, or an external environment state (a user state etc.), and generate an electrical signal and/or data value corresponding to a sensed state. The sensor module ED76 may include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface ED77 may support one or more designated protocols to be used for connecting the electronic device ED01 to another electronic device (the electronic device ED02, etc.) in a wired or wireless manner. The interface ED77 may include a high definition multimedia interface (HDMI), a universal serial bus (USB) interface, an SD card interface, and/or an audio interface.

A connection terminal ED78 may include a connector for physically connecting the electronic device ED01 to another electronic device (the electronic device ED02, etc.). The connection terminal ED78 may include an HDMI connector, a USB connector, an SD card connector, and/or an audio connector (a headphone connector etc.).

The haptic module ED79 may convert electrical signals into mechanical stimuli (vibrations, movements, etc.) or electrical stimuli that are perceivable by a user through tactile or motor sensations. The haptic module ED79 may include a motor, a piezoelectric device, and/or an electrical stimulation device.

The camera module ED80 may capture a still image and a video. The camera module ED80 may include a lens assembly including one or a plurality of lenses, image sensors, image signal processors, and/or flashes. The lens assembly included in the camera module ED80 may collect light emitted from an object that is a target for image capturing.

The power management module ED88 may manage power supplied to the electronic device ED01. The power management module ED88 may be implemented as a part of a power management integrated circuit (PMIC).

The battery ED89 may supply power to the constituent elements of the electronic device ED01. The battery ED89 may include non-rechargeable primary cells, rechargeable secondary cells, and/or fuel cells.

The communication module ED90 may establish a direct (wired) communication channel and/or a wireless communication channel between the electronic device ED01 and another electronic device (the electronic device ED02, the electronic device ED04, the server ED08, etc.), and support a communication through an established communication channel. The communication module ED90 may be operated independently of the processor ED20 (the application processor etc.), and may include one or a plurality of communication processors supporting a direct communication and/or a wireless communication. The communication module ED90 may include a wireless communication module ED92 (a cellular communication module, a short-range wireless communication module, a global navigation satellite system (GNSS) communication module, etc.), and/or a wired communication module ED94 (a local area network (LAN) communication module, a power line communication module, etc.). Among the above communication modules, a corresponding communication module may communicate with another electronic device through the first network ED98 (a short-range communication network such as Bluetooth, WiFi Direct, or infrared data association (IrDA)) or the second network ED99 (a long-range communication network such as a cellular network, the Internet, or a computer network (LAN, WAN, etc.)). These various types of communication modules may be integrated into one constituent element (a single chip, etc.), or may be implemented as a plurality of separate constituent elements (multiple chips). The wireless communication module ED92 may verify and authenticate the electronic device ED01 in a communication network such as the first network ED98 and/or the second network ED99 by using subscriber information (an international mobile subscriber identifier (IMSI), etc.) stored in the subscriber identification module ED96.

The antenna module ED97 may transmit signals and/or power to the outside (another electronic device etc.) or receive signals and/or power from the outside. An antenna may include an emitter formed in a conductive pattern on a substrate (a printed circuit board (PCB) etc.). The antenna module ED97 may include one or a plurality of antennas. In an example case in which the antenna module ED97 includes a plurality of antennas, the communication module ED90 may select, from among the antennas, an appropriate antenna for a communication method used in a communication network such as the first network ED98 and/or the second network ED99. Signals and/or power may be transmitted or received between the communication module ED90 and another electronic device through the selected antenna. Other parts (an RFIC etc.) than the antenna may be included as a part of the antenna module ED97.

Some of the constituent elements may be connected to each other through a communication method between peripheral devices (a bus, general purpose input and output (GPIO), a serial peripheral interface (SPI), a mobile industry processor interface (MIPI), etc.) and may mutually exchange signals (commands, data, etc.).

The command or data may be transmitted or received between the electronic device ED01 and the external electronic device ED04 through the server ED08 connected to the second network ED99. The electronic devices ED02 and ED04 may be of a type that is the same as or different from the electronic device ED01. All or a part of operations executed in the electronic device ED01 may be executed in one or a plurality of other electronic devices (ED02, ED04, and ED08). In an example case in which the electronic device ED01 needs to perform a function or service, the electronic device ED01 may request one or a plurality of other electronic devices to perform part or the whole of the function or service, instead of performing the function or service by itself. The one or a plurality of the electronic devices receiving the request may perform additional functions or services related to the request and transmit a result of the performance to the electronic device ED01. To this end, cloud computing, distributed computing, and/or client-server computing technology may be used.

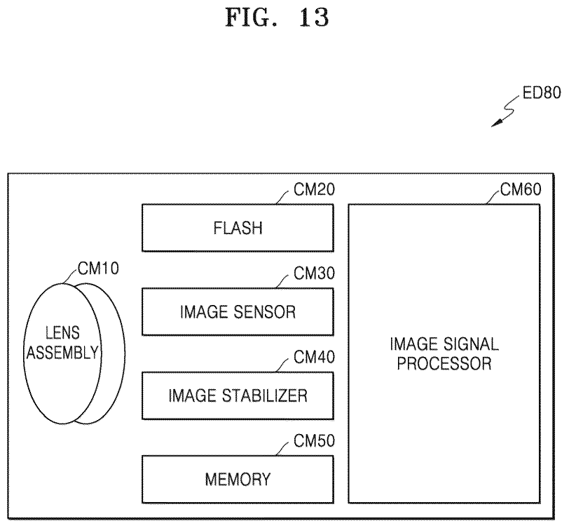

FIG. 13 is a block diagram schematically showing the camera module ED80 provided in the electronic device ED01 of FIG. 12.

The camera module ED80 may include the multispectral imaging sensor described above, or have a structure modified therefrom. Referring to FIG. 13, the camera module ED80 may include a lens assembly CM10, a flash CM20, an image sensor CM30, an image stabilizer CM40, a memory CM50 (a buffer memory, etc.), and/or an image signal processor CM60.

The image sensor CM30 may include the multispectral imaging sensor described above. The multispectral imaging sensor may obtain an image corresponding to an object by converting the light emitted or reflected from the object and transmitted through the lens assembly CM10 into an electrical signal. The multispectral imaging sensor may obtain a hyperspectral image in an ultraviolet to infrared wavelength range.

The image sensor CM30 may further include one or a plurality of sensors selected from image sensors with different properties, such as another RGB sensor, a black and white (BW) sensor, an IR sensor, or a UV sensor, in addition to the multispectral imaging sensor described above. Each of sensors included in the image sensor CM30 may be implemented by a charged coupled device (CCD) sensor and/or a complementary metal oxide semiconductor (CMOS) sensor.

The lens assembly CM10 may collect light emitted from an object for image capturing, and may include any one of the above-described phase modulators. The camera module ED80 may include a plurality of lens assemblies CM10, and in this case, the camera module ED80 may include a dual camera, a 360 degrees camera, or a spherical camera. Some of the lens assemblies CM10 may have the same lens attributes (a viewing angle, a focal length, auto focus, F Number, optical zoom, etc.), or other lens attributes. The lens assembly CM10 may include a wide angle lens or a telephoto lens.

The lens assembly CM10 may be configured and/or focus-controlled to allow two image sensors in the image sensor CM30 to form an optical image of an object at the same position.

The flash CM20 may emit light used to reinforce light emitted or reflected from the object. The flash CM20 may include one or a plurality of light-emitting diodes (LEDs) (a red-green-blue (RGB) LED, a white LED, an infrared LED, an ultraviolet LED, etc.), and/or a xenon lamp.

The image stabilizer CM40 may move, in response to a movement of the camera module ED80 or an electronic device including the same, one or a plurality of lenses included in the lens assembly CM10 or the multispectral imaging sensor in a particular direction or may compensate a negative effect due to the movement by controlling (adjusting a read-out timing, etc.) the movement characteristics of the multispectral imaging sensor. The image stabilizer CM40 may detect a movement of the camera module ED80 or the electronic device ED01 by using a gyro sensor (not shown) or an acceleration sensor (not shown) arranged inside or outside the camera module ED80. The image stabilizer CM40 may be implemented in an optical form.

The memory CM50 may store a part or entire data of an image obtained through the multispectral imaging sensor for a subsequent image processing operation. In an example case in which a plurality of images are obtained at high speed, only low resolution images are displayed while the obtained original data (Bayer-Patterned data, high resolution data, etc.) is stored in the memory CM50. Then, the original data of a selected (user selection, etc.) image may be transmitted to the image signal processor CM60. The memory CM50 may be incorporated into the memory ED30 of the electronic device ED01, or configured to be an independently operated separate memory.

The image signal processor CM60 may perform one or more image processing on the image obtained through the image sensor CM30 or the image data stored in the memory CM50. A configuration of a processor 500 therefor may be included in the image signal processor CM60.

The image processing may include depth map generation, three-dimensional modeling, panorama generation, feature point extraction, image synthesis, and/or image compensation (noise reduction, resolution adjustment, brightness adjustment, blurring, sharpening, softening, etc.). The image signal processor CM60 may perform control (exposure time control, or read-out timing control, etc.) on constituent elements (the image sensor CM30, etc.) included in the camera module ED80. The image processed by the image signal processor CM60 may be stored again in the memory CM50 for additional processing or provided to external constituent elements (the memory ED30, the display apparatus ED60, the electronic device ED02, the electronic device ED04, the server ED08, etc.) of the camera module ED80. The image signal processor CM60 may be incorporated into the processor ED20, or configured to be a separate processor operated independently of the processor ED20. In an example case in which the image signal processor CM60 is configured by a separate processor from the processor ED20, the image processed by the image signal processor CM60 may undergo additional image processing by the processor ED20 and then displayed through the display apparatus ED60.

The electronic device ED01 may include a plurality of camera modules ED80 having different attributes or functions. In this case, one of the camera modules ED80 may be a wide angle camera, and another may be a telephoto camera. Similarly, one of the camera modules ED80 may be a front side camera, and another may be a read side camera.

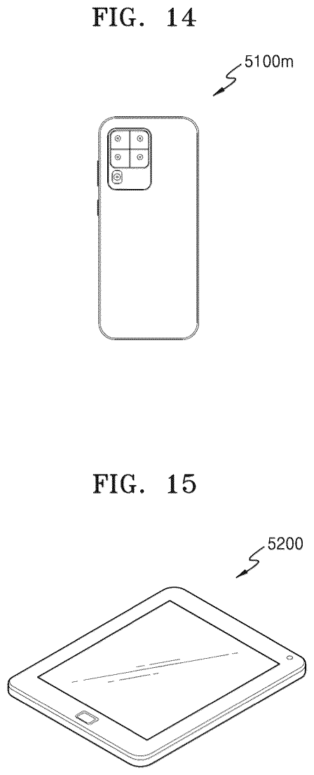

FIGS. 14 to 23 illustrate various examples of an electronic device adopting a multispectral imaging sensor, according to some embodiments.

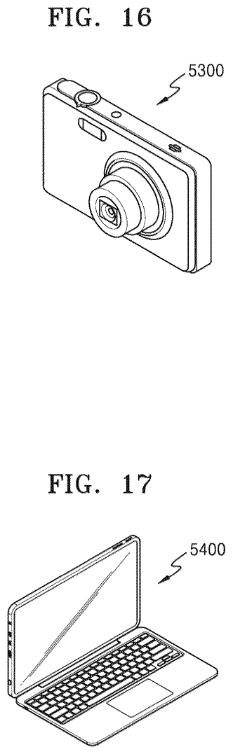

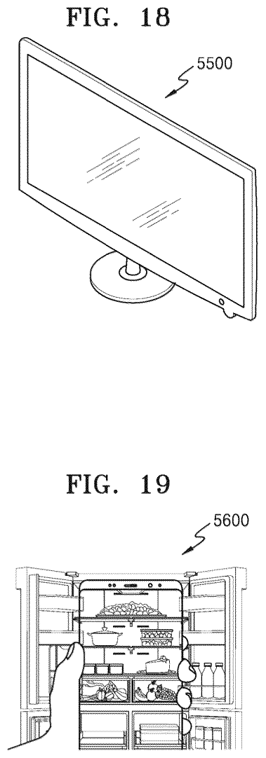

The multispectral imaging sensor may be applied to a mobile phone or smartphone 5100m illustrated in FIG. 14, a tablet or smart tablet 5200 illustrated in FIG. 15, a digital camera or camcorder 5300 illustrated in FIG. 16, a notebook computer 5400 illustrated in FIG. 17, or a television or smart television 5500 illustrated in FIG. 18. For example, the smartphone 5100m or the smart tablet 5200 may include a plurality of high-resolution cameras, on each of which a high-resolution image sensor is mounted. Depth information of objects in an image may be extracted, out-focusing of an image may be adjusted, or objects in an image may be automatically identified by using high-resolution cameras.

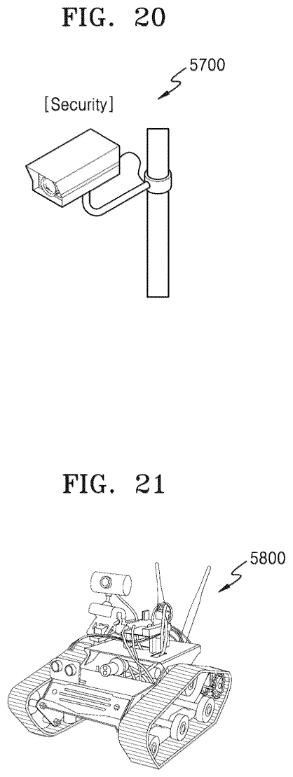

Furthermore, the multispectral imaging sensor may be applied to a smart refrigerator 5600 illustrated in FIG. 19, a security camera 5700 illustrated in FIG. 20, a robot 5800 illustrate din FIG. 21, or a medical camera 5900 illustrated in FIG. 22. For example, the smart refrigerator 5600 uses the multispectral imaging sensor to automatically recognize food in the refrigerator and inform a user of the presence of specific food, the type of food received or drawn, and the like through a smartphone. The security camera 5700 may provide an ultra-high resolution image and, by using high sensitivity, recognize objects or people in an image even in a dark environment. The robot 5800 may provide high resolution images when used in disaster or industrial sites that cannot be directly accessed by humans. The medial camera 5900 may provide a high-resolution image for diagnosis or operation and dynamically adjust a field of sight.

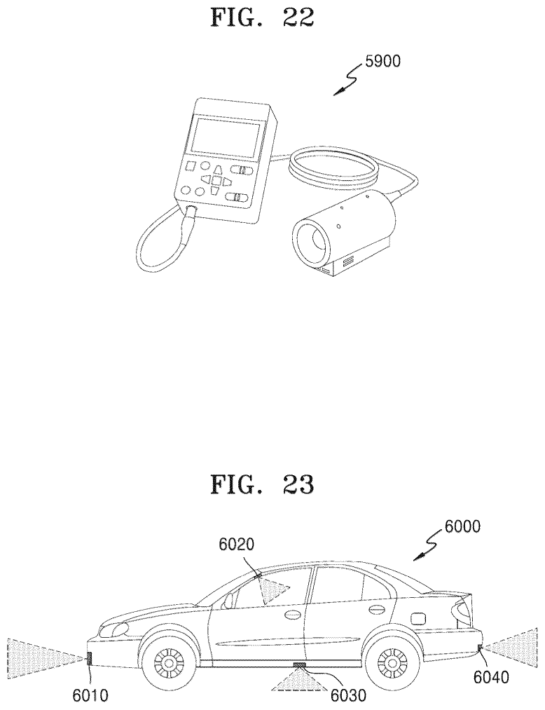

Furthermore, the multispectral imaging sensor may be a vehicle 6000 as illustrated in FIG. 23. The vehicle 6000 may include a plurality of vehicle cameras 6010, 6020, 6030, and 6040 located at various positions. Each of the vehicle cameras 6010, 6020, 6030, and 6040 may include the multispectral imaging sensor according to an embodiment. The vehicle 6000 may provide a driver with various pieces of information about the inside or the vicinity of the vehicle 6000 by using the vehicle cameras 6010, 6020, 6030, and 6040, and provide information needed for autonomous driving by automatically recognizing objects or people within an image.

The above-described method may be recorded on a non-transitory computer-readable recording medium having recorded thereon one or more programs including commands for executing the method. Examples of a computer-readable recording medium may include magnetic media such as hard discs, floppy discs, and magnetic tapes, optical media such as CD-ROM or DVD, magneto-optical media such as floptical disks, and hardware devices such as ROM, RAM flash memory, which are specially configured to store and execute a program command. An example of a program command may include not only machine codes created by a compiler, but also high-level programming language executable by a computer using an interpreter

It should be understood that the apparatus for denoising an image described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An apparatus for denoising an image obtained through a multispectral imaging sensor, the apparatus comprising: a memory configured to store one or more instructions, and
at least one processor configured to execute the one or more instructions to:
divide a wavelength band of an input image into a plurality of sub-wavelength bands, each of the plurality of sub-wavelength bands corresponding to one of a plurality of channels;
obtain, for each of the plurality of channels, a first denoising image and a differential image by sub-sampling the input image into a plurality of sub-sampled images, each corresponding to one of the plurality of channels, the first denoising image obtained by performing a denoising operation on a sub-sampled image for the respective channel and the differential image obtained based on a difference between the first denoising image and the sub-sampled image for the respective channel;
obtain, for each of the plurality of channels, a second denoising image by performing preprocessing on the differential image of the respective channel and performing principal component analysis and projection on the preprocessed differential image of the respective channel; and
generate an output image by summing the first denoising image and the second denoising image obtained for each of the plurality of channels.

2. The apparatus of claim 1, wherein the at least one processor is further configured to:
receive the input image including a visible light band and a non-visible light band,
wherein the plurality of channels comprises at least four channels.

3. The apparatus of claim 1, wherein each of the plurality of sub-sampled images for the respective channels has a size of at least one multispectral filter array.

4. The apparatus of claim 1, wherein the at least one processor is further configured to obtain the first denoising image and the differential image by applying a non-local means (NLM) algorithm to the plurality of sub-sampled images for the respective channels.

5. The apparatus of claim 1, wherein the at least one processor is further configured to apply a bilateral filter (BF) algorithm and a bilinear interpolation to the differential image of each of the plurality of channels.

6. The apparatus of claim 5, wherein the at least one processor is further configured to linearly transform the differential image preprocessed for each of the plurality of channels into a plurality of eigen vectors and a plurality of eigen values by performing the principal component analysis on a plurality of pixels of the differential image preprocessed for each of the plurality of channels.

7. The apparatus of claim 6, wherein the at least one processor is further configured to:
determine a priority of the plurality of eigen vectors based on the plurality of eigen values; and
obtain the second denoising image by selecting and projecting at least one eigen vector from among the plurality of eigen vectors, based on the determined priority.

8. The apparatus of claim 7, wherein the at least one processor is further configured to obtain the second denoising image by selecting and projecting a first number of eigen vectors of the plurality of eigen vectors.

9. The apparatus of claim 7, wherein the at least one processor is further configured to obtain the second denoising image by selecting and projecting a number of eigen vectors set based on properties of the input image from among the plurality of eigen vectors.

10. The apparatus of claim 1, wherein the at least one processor is further configured to:
down-sample the second denoising image; and
generate the output image by summing the first denoising image and the down-sampled second denoising image of each of the plurality of channels.

11. An operation method of an apparatus for denoising an image obtained through a multispectral imaging sensor, the operation method comprising:
dividing a wavelength band of an input image into a plurality of sub-wavelength bands, each of the plurality of sub-wavelength bands corresponding to one of a plurality of channels;
obtaining, for each of the plurality of channels, a first denoising image and a differential image by sub-sampling the input image into a plurality of sub-sampled images, each corresponding to one of the plurality of channels, the first denoising image obtained by performing a denoising operation on a sub-sampled image for the respective channel and the differential image obtained based on a difference between the first denoising image and the sub-sampled image for the respective channel;
obtaining, for each of the plurality of channels, a second denoising image by performing preprocessing on the differential image of the respective channel and performing principal component analysis and projection on the preprocessed a differential image of the respective channel; and
generating an output image by summing the first denoising image and the second denoising image obtained for each of the plurality of channels.

12. The method of claim 11, further comprising:
receiving the input image including a visible light band and a non-visible light band,
wherein the plurality of channels comprises at least four channels.

13. The method of claim 11, wherein each of the plurality of sub-sampled images for the respective channels has a size of at least one multispectral filter array.

14. The method of claim 11, wherein the obtaining of the first denoising image and the differential image comprises obtaining the first denoising image and the differential image by applying a non-local means (NLM) algorithm to the plurality of sub-sampled images for the respective channels.

15. The method of claim 11, wherein the performing of the preprocessing on the differential image comprises applying a bilateral filter (BF) algorithm and a bilinear interpolation to the differential image of each of the plurality of channels.

16. The method of claim 15, wherein the obtaining of the second denoising image comprises linearly transforming the differential image preprocessed for each of the plurality of channels into a plurality of eigen vectors and a plurality of eigen values by performing the principal component analysis on a plurality of pixels of the differential image preprocessed for each of the plurality of channels.

17. The method of claim 16, further comprising:
determining a priority of the plurality of eigen vectors based on the plurality of eigen value; and
obtaining the second denoising image by selecting and projecting at least one eigen vector from among the plurality of eigen vectors, based on the determined priority.

18. The method of claim 17, further comprising obtaining the second denoising image by selecting and projecting a preset number of eigen vectors of the plurality of eigen vectors.

19. The method of claim 17, further comprising obtaining the second denoising image by selecting and projecting a number of eigen vectors set based on properties of the input image from among the plurality of eigen vectors.

20. The method of claim 11, wherein the generating of the output image comprises:
down-sampling the second denoising image; and
generating the output image by summing the first denoising image and the down-sampled second denoising image, for each of the plurality of channels.
